(19) United States
(12) Patent Application Publication
(10) Pub. No.: US 2018/0097744 A1
(43) Pub. Date: Apr. 5, 2018

(54) Cloud Resource Provisioning for Large-Scale Big Data Platform

(71) Applicant: Futurewei Technologies, Inc., Plano, TX (US)

(72) Inventors: Luhui Hu, Bellevue, WA (US); Hui Zang, Cupertino, CA (US)

(21) Appl. No.: 15/286,313

(22) Filed: Oct. 5, 2016

(51) Int. Cl. H04L 12/911; G06N 5/02; H04L 29/08

(52) U.S. Cl. CPC H04L 47/823; H04L 67/10; G06N 5/022

(57) ABSTRACT

A method implemented in a cloud-based data system includes a central controller receiving time-stamped reports from a plurality of agents including a server status and a server resource usage, calculating a number of active servers and a sum of resource usage on each server per interval based on each time-stamped report, generating a prediction model based on data results generated from calculating the number of active servers and the sum of resource usage per interval, predicting a number of servers needed in the cloud-based system based on the prediction model, generating a forecasting model to forecast an amount of resource usage at a future date, based on time series data associated with calculating the sum of resource usage over multiple intervals, and using the prediction model to predict whether a different number of servers is needed at the future date based on the forecasted amount of resource usage.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Cloud computing is a model for delivering hosted services, which may be made available to users, e.g., over the Internet. Multiple hardware components may be provisioned to form a cloud, which may allow its hardware resources to be shared between computer services (e.g., computation and data storage) to optimize performance. Thus, cloud computing enables ubiquitous, convenient, on-demand network access to a shared pool of configurable resources that can be provisioned and employed with minimal management effort or service provider interaction. By employing cloud computing resources, provisioners may deploy and manage emulations of particular computer systems through a network, which provide convenient access to the computing resources.

A platform is a cloud-based software system with at least one component (e.g., program or process). Cloud platforms may provide services and computing resources according to various models such as Infrastructure as a Service (IaaS), Platform as a Service (PaaS), and Software as a Service (SaaS). In IaaS, computer infrastructure is delivered as a service, and the computing equipment is generally owned and operated by the service provider. In PaaS, software tools and underlying equipment used by developers to develop software solutions may be provided as a service and hosted by the service provider. SaaS includes licensing software for providing a service on demand, where a service provider may host the licensing software or deploy the licensing software to a provisioner for a given duration.

### SUMMARY

In one embodiment, the disclosure includes a method implemented in a cloud-based data system. The method includes a central controller receiving time-stamped reports from a plurality of agents, where each time-stamped report includes a server status and a server resource usage when the each time-stamped report is generated by a respective agent. The method also includes the central controller calculating a number of active servers and a sum of resource usage on each server per interval based on each time-stamped report, generating a prediction model based on data results generated from calculating the number of active servers and the sum of resource usage per interval, predicting a number of servers needed in the cloud-based system based on the prediction model, generating a forecasting model to forecast an amount of resource usage at a future date, based on time series data associated with calculating the sum of resource usage over multiple intervals, and using the prediction model to predict whether a different number of servers is needed at the future date based on the forecasted amount of resource usage.

In some embodiments, the resource usage included in each time-stamped report indicates an amount of memory used by the server at the time of generating the time-stamped report, an amount of computing resources used by the server at the time of generating the time-stamped report, or both. In one or more embodiments, the prediction model may include at least one of a machine learning model, a decision tree learning model, a graphical model, or a linear model. In one or more embodiments, the prediction model may include a regression model. In one or more embodiments, the regression model may include a logistic regression model or a linear regression model. In one or more embodiments, the forecasting model may include an autoregressive integrated moving average (ARIMA) model or an autoregressive moving average (ARMA) model. In one or more embodiments, the method may further include training the prediction model using data results generated from calculating the number of active servers and the sum of resource usage over multiple intervals.

In another embodiment, the disclosure includes a central controller coupled to a cloud-based system via a plurality of agents. The central controller includes a non-transitory memory storage comprising instructions, and one or more processors in communication with the memory. The one or more processors execute the instructions to receive time-stamped reports from a plurality of agents, where each time-stamped report includes a server status and a server resource usage when the each time a time-stamped report is generated by a respective agent; calculate a number of active servers and a sum of resource usage on each server per interval based on each time-stamp report; generate a prediction model based on data results generated from calculating the number of active servers and the sum of resource usage per interval; predict a number of servers needed in the cloud-based system based on the prediction model; generate a forecasting model to forecast an amount of resource usage at a future date, where the forecasting model is based on time series data associated with calculating the sum of resource usage over multiple intervals; and use the prediction model to predict whether a different number of servers is needed at the future date based on the forecasted amount of resource usage.

In some embodiments, the resource usage included in each time-stamped report indicates an amount of memory used by the server at the time of generating the time-stamped report, an amount of computing resources used by the server at the time of generating the time-stamped report, or both. In one or more embodiments, the prediction model may include at least one of a machine learning model, a decision tree learning model, a graphical model, or a linear model. In one or more embodiments, the prediction model may include a regression model. In one or more embodiments, the regression model may include a logistic regression model or a linear regression model. In one or more embodiments, the forecasting model may include an autoregressive integrated moving average (ARIMA) model or an autoregressive moving average (ARMA) model. In one or more embodiments, the central controller may be configured to train the prediction model using data results generated from calculating the number of active servers and the sum of resource usage over multiple intervals.

In yet another embodiment, the disclosure includes non-transitory computer readable medium storing computer instructions, that when executed by one or more processors, cause the one or more processors to perform the steps of receiving time-stamped reports from a plurality of agents, where each time-stamped report includes a server status and a server resource usage when the each time-stamped report is generated by a respective agent; calculating a number of active servers and a sum of resource usage on each server per interval; generating a prediction model based on data results generated from calculating the number of active servers and the sum of resource usage per interval; predicting a number of servers needed in the cloud-based system based on the prediction model; generating a forecasting model to forecast an amount of resource usage at a future date, where the forecasting model is based on time series data associated with calculating the sum of resource usage over multiple intervals; and using the prediction model to predict whether a different number of servers is needed at the future date based on the forecasted amount of resource usage.

In some embodiments, the resource usage included in each time-stamped report indicates an amount of memory used by the server at the time of generating the time-stamped report, an amount of computing resources used by the server at the time of generating the time-stamped report, or both. In one or more embodiments, the prediction model may include at least one of a machine learning model, a decision tree learning model, a graphical model, or a linear model. In one or more embodiments, the prediction model may include a regression model. In one or more embodiments, the regression model may include a logistic regression model or a linear regression model. In one or more embodiments, the forecasting model may include an autoregressive integrated moving average (ARIMA) model or an autoregressive moving average (ARMA) model. In one or more embodiments, the one or more processors may further perform the step training the prediction model using data results generated from calculating the number of active servers and the sum of resource usage over multiple intervals.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram of a system comprising a communications network.

FIG. 2 is a diagram of a system according to an embodiment of the disclosure.

FIG. 3 is a graph of a forecasting model according to an embodiment of the disclosure.

FIG. 4 is a flowchart of a method according to an embodiment of the disclosure.

FIG. 5 is a diagram of a network device according to an embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

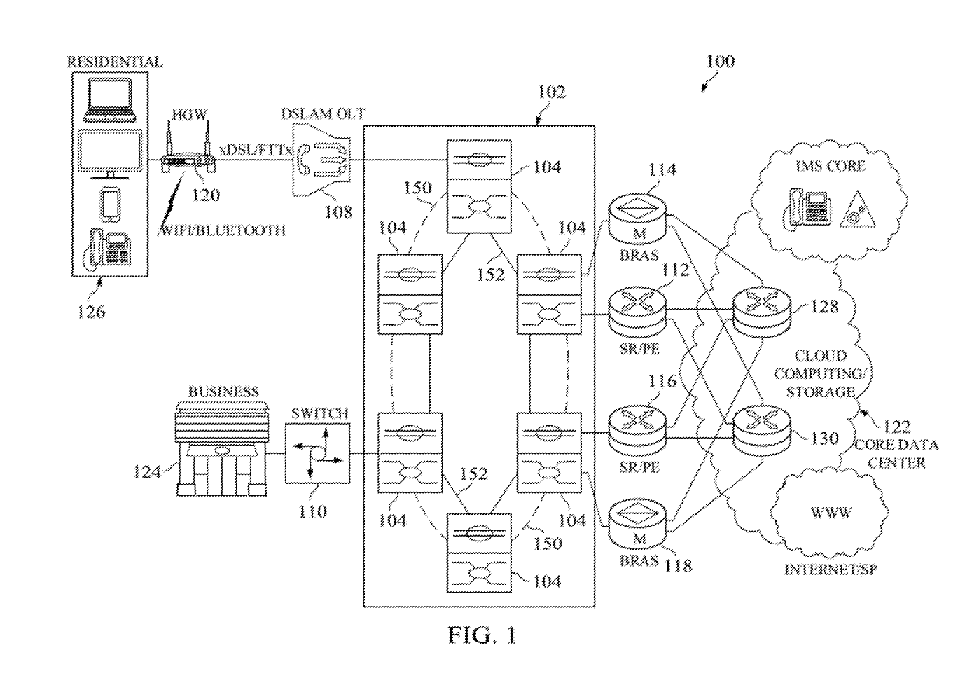

FIG. 1 is a diagram of a system 100 comprising a communications network 102. The system 100 may be configured to support packet transport and optical transport services among network elements using the network 102. For example, the system 100 may transport data traffic for services between clients 124 and 126 and a service provider 122 (such as a core data center, for example). Examples of such services may include, but are not limited to, Internet service, virtual private network (VPN) services, value added service (VAS) services, Internet Protocol Television (IPTV) services, content delivery network (CDN) services, Internet of things (IoT) services, data analytics applications, and Internet Protocol Multimedia services. The system 100 may comprise a network 102, network elements 108, 110, 112, 114, 116, 118, 120, 128, and 130, service provider 122, and clients 124 and 126. The system 100 may be configured as shown or in any other suitable manner.

The network 102 may include a network infrastructure that comprises a plurality of integrated network nodes 104, and it may be configured to support transporting both optical data and packet switching data. Moreover, the network 102 may implement the network configurations to configure flow paths or virtual connections between client 124, client 126, and service provider 122 via the integrated network nodes 104. In some aspects, the network 102 may be a backbone network which connects a cloud computing system of the service provider 122 to clients 124 and 126. The network 102 may also connect a cloud computing system of the service provider 122 to other systems such as an external network or Internet, other cloud computing systems, data centers, and any other entity desiring access to the service provider 122.

The integrated network nodes 104 may comprise reconfigurable hybrid switches configured for packet switching and optical switching. In an embodiment, one or more integrated network nodes 104 may comprise a packet switch, an optical data unit (ODU) cross-connect, and a reconfigurable optical add-drop multiplex (ROADM). The integrated network nodes 104 may be coupled to each other and to other network elements using virtual links 150 and physical links 152. For example, virtual links 150 may be logical paths between integrated network nodes 104 and physical links 152 may be optical fibers that form an optical wavelength division multiplexing (WDM) network topology. The integrated network nodes 104 may be coupled to each other using any suitable virtual links 150 or physical links 152 as would be appreciated by one of ordinary skill in the art upon viewing this disclosure. The integrated network nodes 104 may consider the network elements 108-120 as dummy terminals (DTs) that represent service and/or data traffic origination points and destination points.

Network elements 108-120, 128, and 130 may include, but are not limited to, clients, servers, broadband remote access servers (BRAS), switches, routers, service router/provider edge (SR/PE) routers, digital subscriber line access multiplexer (DSLAM) optical line terminal (OTL), gateways, home gateways (HGWs), service providers, PE network nodes, customers edge (CE) network nodes, an Internet Protocol (IP) router, and an IP multimedia subsystem (IMS) core. Clients 124 and 126 may include user devices in residential and business environments. For example, client 126 is in a residential environment and may communicate data with the network 102 via network elements 120 and 108, and client 124 is in a business environment and may communicate data with the network 102 via network element 110.

Examples of service provider 122 may include, but are not limited to, an Internet service provider, an IPTV service provider, an IMS core, a private network, an IoT service provider, and a CDN. In one embodiment, the service provider 122 may be a core data center that pools computing or storage resources to serve multiple clients 124 and 126 that request services from the service provider 122. For example, the service provider 122 may use a multi-tenant model where fine-grained resources may be dynamically assigned to a client specified implementation and reassigned to other implementations according to consumer demand. Moreover, the service provider 122 may automatically control and optimize resource use by leveraging a metering capability at some level of abstraction appropriate to the type of resource (e.g., storage, processing, bandwidth, and active user accounts).

In some implementations, the service provider 122 may include a cloud computing system configured to provide cloud-based services to requesting clients 124 and 126, e.g., via the IaaS, PaaS, or SaaS model. The cloud computing system, cloud computing, or cloud services may refer to a group of servers, storage elements, computers, laptops, cell phones, and/or any other types of network devices connected together by an IP network in order to share network resources (e.g., servers, processors, memory, applications, virtual machines, services, etc.) stored at one or more data centers of the service provider 122. As used herein, the service provider 122 may alternately refer to a cloud provider 122. A cloud provider 122 may comprise a cloud infrastructure or platform (e.g., Kubernetes and Mesos platforms) managed as a large resource pool for multiple clusters, which may each include a cluster of hardware units or servers for data processing and analytics. Data analytics may generally include the use of various computing models to evaluate large data sets, e.g., to solve complex data problems.

A large-scale platform typically demands many resources to effectively process and analyze large quantities of data, also known as “big data,” even in a very short time period. Big data may range from a few terabytes (TBs) of data to many petabytes (PBs) of data or greater (e.g., as technology advances). Big data processing and analytics may demand different types of resources, such as computing resources, networking resources, and storage resources. An on-premises solution for big data platforms is often restricted by the limit of such resources.

A recent trend involves a cloud computing solution that provides requested resources without requiring providers (e.g., provider 122) to establish a computing infrastructure in order to service consumers such as clients 124 and 126. Clients 124 and 126 may have little control or knowledge over the exact location of the provided resources, but may be able to specify location at a higher level of abstraction (e.g., country, state, or data center). With a cloud computing solution, computing capabilities or storage resources may be provisioned and made available over the network 102. Such capabilities and resources may be elastically provisioned and released, in some cases automatically, to scale rapidly outward and inward based on demand.

The cloud provider 122 may provision computing resources for a cloud according to one or more models, e.g., IaaS, PaaS, SaaS, etc. Regardless of the model used, one challenge for deploying cloud computing in large-scale data platforms and infrastructures involves the provisioning of adequate hardware resources, such as central processing units (CPUs), storage devices, control boards, networks, etc. For example, an entire set of hardware resources may need to be pre-planned and provisioned in advance, such as to ensure a cloud has sufficient run-time resources to provide auto-scaling and dynamic allocations. However, it is often time-consuming and/or costly to acquire, install, and provision the hardware resources in advance.

In some cases, a provider may purchase or rent resources in order to provide services requested by clients 124 and 126. For example, in an IaaS model, a PaaS provider may rent resources from an IaaS provider according to different fee structures, but the PaaS provider may typically be required to pay regardless of whether all resources are actually used. To avoid sunk costs, a conservative provider may rent a minimum amount of resources believed to be necessary. However, a shortage of resources may occur if insufficient resources are not already in place, in which case the provider may suffer a loss in potential revenue. To avoid such losses, the provider may rent a relatively large quantity of resources, but at the expense of higher infrastructure fees and potential sunk costs, as any unused resources would likely go to waste. Accordingly, it may be important to pre-plan and provision resources with precision.

Yet due to the fast growing nature of data in big data environments, it can be challenging to ensure sufficient resources are available in a cloud. That is, the amount of data managed by a cloud may widely fluctuate. For instance, data within one cloud may dynamically increase on a daily basis, such as from TBs of data one day to PBs of data the next. Consequently, the cloud may need to employ a large and complex system of processing and analytic tools to manage such rapidly increasing data in an effective manner. Otherwise, the overall data volume may eventually exceed the overall capacity of the cloud, thereby overloading the cloud.

Disclosed herein are embodiments of a cloud-based solution for provisioning resources to large-scale data platforms in a cost-efficient manner. The solution may employ a cognitive forecasting scheme to predict an amount of resources the cloud will require during operation to perform all necessary big data processing and analytics. To this end, a system may automatically collect samples of time-series data and metrics associated with multiple clusters performing different big data processing and analytics on the cloud. The samples may include information such as different types of resources used by different types of clusters, which may each have different resource requirements and/or trends. The system may use such information to determine the resource required by each cluster and then comprehensively aggregate those resource requirements to plan and provision the overall resources for the cloud. Further, the cognitive forecasting scheme may utilize learning algorithms to predict a quantity of resources the cloud may need to operate at a certain time in the future based on time series data collected over multiple intervals. These and other features are detailed below.

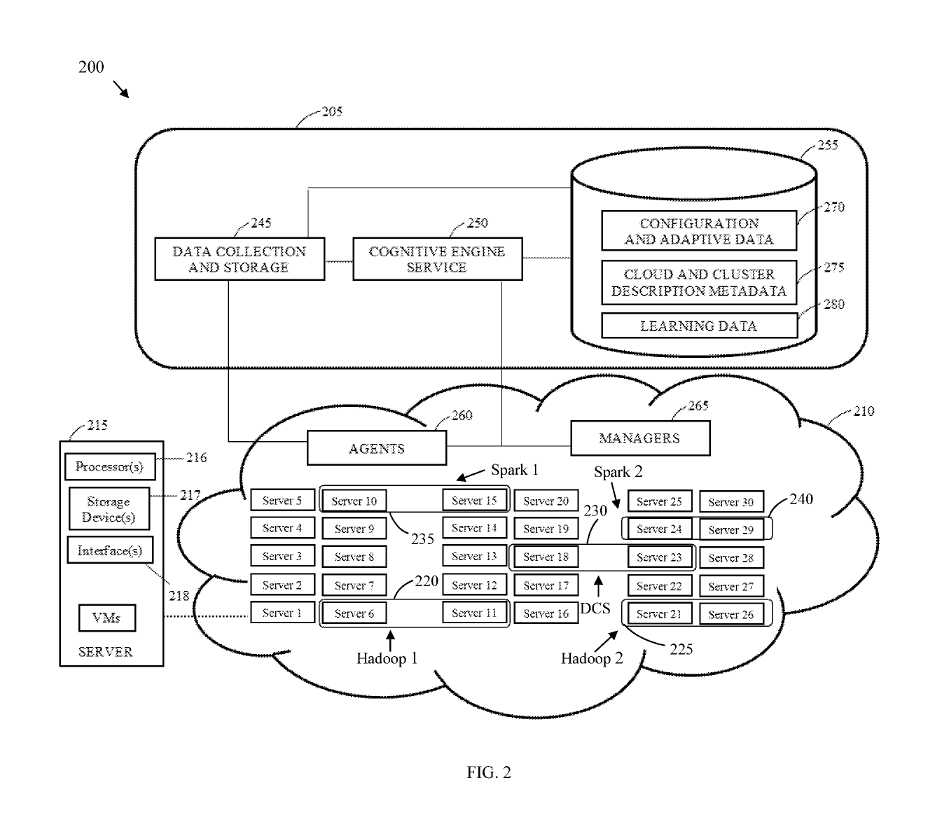

FIG. 2 is a system 200 for pre-planning and provisioning cloud resources according to an embodiment of the disclosure. In some implementations, the system 200 may be coupled to one or more components of the system 100 in FIG. 1. Briefly, for example, the network 102 in FIG. 1 may serve as a backbone network to couple entities such as clients 124 and 126 and a cloud or service provider 122 to the system 200. The system 200 comprises a central controller 205 coupled to a cloud 210, which may be managed by an operator such as cloud provider 122. The central controller 205 may include a microprocessor, a microcontroller, an application-specific integrated circuit (ASIC), a field programmable gate array (FPGA), or any suitable processing circuitry. The cloud 210 comprises a plurality of computational nodes or physical servers 215, denoted individually as 215-1, 215-2 . . . 215-30. The servers 215 may be arranged vertically as shown, or according to any suitable arrangement. Moreover, the servers 215 may be mounted in a set of racks (not shown), with each rack including a switch or router to communicate traffic between different clusters. Further, the cloud 210 may include a number of external switches that connect the racks to other devices in the cloud 210 and/or external sources.

In general, each server 215 may include various network devices such as one or more CPUs 216, storage devices 217, and interfaces 218. The CPU 216 may include any suitable processing circuitry such as discussed above with respect to the central controller 205. The storage device 217 may include a computer-readable storage medium having instructions such as executable code of one or more software programs. In some aspects, the storage device 217 may comprise electronic random access memory (RAM), static RAM (SRAM), dynamic RAM (DRAM), read-only memory (ROM), erasable programmable ROM (EPROM), flash memories, hard disks, optical disks, magnetic tapes, etc. The interface 218 may include an input/output (I/O) interface, a graphical user interface (GUI), or any suitable interface to communicate with other devices in the cloud 210 and/or external devices, e.g., the central controller 205.

In some implementations, each server 215 may include multiple resource units such as containers and virtual machines (VMs). As used herein, the term “resource unit” is meant to be understood broadly as any suitable resource such as, but not limited to, different forms of CPU, memory, storage, network, security, etc. Moreover, a resource unit may be implemented in different platforms of operating systems, and even platforms with no operating systems. Additionally or alternatively, a resource unit may comprise a basic resource node or resource element for a service or platform. Accordingly, a resource unit may refer to any suitable resource unit such as described herein. For simplicity, however, the following discussion may focus on examples where a resource unit comprises a VM.

Each server 215 may generate multiple VMs to establish a cluster for big data processing and analytics. For example, the cloud 210 may utilize hypervisor technology to generate multiple VMs in each of the individual servers 215-1 . . . 215-30, where a collection of VMs may be used to form a cluster, which may include any suitable types of cluster such as, but not limited, Hadoop and Spark clusters. A Hadoop cluster may be used to perform distributed processing of large quantities of data across a cluster of commodity hardware such as servers, while a Spark cluster may be used to process, analyze, and store data in a cluster of servers.

In an embodiment, the cloud 210 may comprise multiple clusters. According to an implementation, the cloud 210 includes a first Hadoop cluster 220, a second Hadoop cluster 225, a data collection service (DSC) cluster 230, a first Spark cluster 235, and a second Spark cluster 240. In other implementations, the cloud 210 may comprise more or less clusters and/or different types of clusters. Each server 215 may allocate different VMs to different clusters. For instance, the first Spark cluster 235 may include at least one VM in server 215-10 and at least one VM in server 215-15, while another cluster (not shown) may include one or more different VMs in server 215-10 and/or server 215-15. Furthermore, some cloud services may share the same VMs, but each cloud service may be viewed as being in a single overall cloud cluster from the perspective of a cloud resource provisioner.

As shown in FIG. 2, the central controller 205 may comprise a data collection and storage module 245, a cognitive engine service module 250, and at least one storage device 255. The data collection and storage module 245 may configured to obtain time-series data (TSD) and metrics associated with the servers 215-1, 215-2 . . . 215-30 via a plurality of agents 260-1, 260-2 . . . 260-30, respectively, e.g., each agent 260 may reside on a respective server 215. As discussed below, the agents 260 may monitor the servers 215 and report results to the data collection and storage module 245. The data collection and storage module 245 may supply the reports to the cognitive engine service module 250, which may then store the reports in the storage device 255. In some aspects, the data collection and storage module 245 may directly store the reports in the storage device 255. The cognitive engine service module 250 may then retrieve the stored reports at later time for data processing and analytics.

The cognitive engine service module 250 may provision resources to the clusters 220-240 based on information obtained from the data collection and storage module 245 and/or information stored in the storage device 255. In general, the types of resources and/or quantities of resources may vary according to the type of each cluster 220-240. For instance, clusters such as the first and second Spark clusters 235 and 240 may include VMs that employ RAM-intensive data processing and analytics, and therefore, the cognitive engine service module 250 may provision more RAM resources to these clusters 235 and 240 than to clusters 220 and 225. Clusters such as the first and second Hadoop clusters 220 and 225 may employ VMs that employ CPU-intensive data processing and analytics, and therefore, the cognitive engine service module 250 may provision more CPU resources to these clusters 220 and 225 than to clusters 230 and 240. Clusters such as the DCS cluster 230 may include VMs that employ network-intensive data processing and analytics, and therefore, the cognitive engine service module 250 may provision more network resources to this cluster 230 than to clusters 220, 225, 234, and 240.

According to some implementations, the cognitive engine service module 250 may provision the various types of resources via managers 265, which may be configured as regional managers such as Distributed Resource and Configuration Managers (DCRMs). Each manager 265 may reside on a server 215 associated with a particular cluster managed by that manager 265. For example, a manager 265 configured to manage the first Spark cluster 235 may reside on either server 215-10 or server 215-15. Accordingly, the cloud 210 may include at least one agent 260 per server 215, and at least one manager 265 per cluster 220-240.

As shown in FIG. 2, the storage device 255 may comprise multiple bins of data. For example, the storage device 255 may comprise a first bin 270 for storing configuration and adaptive information associated with various types of big data, a second bin 275 for storing metadata associated with the cloud 210 and clusters 220-240, and a third bin 280 for storing learning data. In some aspects, two or all three of the bins 270-280 may be combined in a single bin. Additionally or alternatively, the bins 270-280 may comprise three separate storage devices, i.e., rather than a combination of bins stored in the storage device 255. Furthermore, the storage device 255 and bins 270-280 may comprise any suitable storage mediums, such as discussed above with respect to a storage device 217 in a server 215.

In an embodiment, the central controller 205 may be configured to generate at least two different models to pre-plan and provision optimal quantities of resources for a cloud (e.g., the cloud 210 in FIG. 2). First, the central controller 205 may generate a prediction model to determine how much hardware a cloud may need in order to meet overall resource demands during runtime. Second, the central controller 205 may generate a forecasting model to pre-determine how much additional hardware the cloud may need in order for the cloud to continue running successfully for a desired duration. To that end, the central controller 205 may initially apply the forecasting model to determine a sum of resources that the existing cloud may require after the desired duration, where the output of the forecasting model represents the sum of resources. In turn, the central controller 205 may apply the output of the forecasting model as an input to the prediction model, which may generate an output corresponding to an additional amount of hardware the cloud may need to run successfully for the desired duration.

In operation, the central controller 205 may configure the agents 260-1 . . . 260-30 to periodically record data in the respective servers 215-1 . . . 215-30 at certain time points. For example, the recorded data may include at least a first value indicating a status of a respective server 215 at a particular time point, and at least a second value indicating a resource usage on that server 215 at that particular time point. The first value may simply comprise a binary bit (e.g., “0” or “1”) to indicate a status of a respective server such as whether it is busy or not (e.g., active or inactive). In one aspect, the second value may indicate a resource usage corresponding to a CPU usage, a memory usage, or any other suitable type of resource usage. In other aspects, the second value may comprise multiple values, each indicating a resource usage and a type of resource used on a respective server 215. Additionally or alternatively, the agents 260-1 . . . 260-30 may monitor resources used on each VM in the respective servers 215-1 . . . 215-30 and record multiple values indicating resource usages on each of the VMs in the respective servers 215-1 . . . 215-30.

For simplicity, the following discussion will refer to aspects in which the agents 260-1 . . . 260-30 each record resource usage values that indicate a CPU usage and a memory usage on the servers 215-1 . . . 215-30, respectively (e.g., usage of the CPU 216 and the memory 217 of each server 215). Thus, at each time point, the agents 260-1 . . . 260-30 will each record such usages in time stamps. As used herein, the term “time stamps” may refer to “time-stamped reports” containing values indicating (1) whether or not a respective server 215-1 . . . 215-30 is busy; (2) a CPU usage on the respective servers 215-1 . . . 215-30; and (3) a memory usage on the respective servers 215-1 . . . 215-30.

After each periodic time point, the agents 260-1 . . . 260-30 may send the time-stamped reports to the data collection and storage module 245 in the central controller 205. In turn, the central controller 205 may determine how many servers 215 were busy at each time point. The central controller 205 may also add each CPU usage and memory usage recorded by the agents 260 to determine a sum of CPU usage and a sum of memory usage on the servers 215 at each time point. For convenience, Y may denote the total number of servers 215 busy at a particular time point, while X1 and X2 may denote the sum of CPU usage and the sum of memory usage (respectively) on the servers 215 at that particular time point. Data obtained from the agents 260 (e.g., via time-stamped reports) and the central controller 205 may be shared with the cognitive engine service module 250 and/or stored in the storage device 255 for future data processing and analytics. An agent may not be necessary in some cases. For instance, the cloud 210 may also include agentless servers or agentless resource units, in which case the central controller 205 may obtain data from another source and/or directly from the agentless servers and agentless resource units.

In an embodiment, the central controller 205 may utilize data stored in the storage device 255, such as a plurality of time-stamped reports received from the agents 260, to generate a prediction model to determine a number of servers 215 the cloud 210 may need in the future based at least partly on current CPU usages and memory usages. According to one aspect, the central controller 205 may summarize data in time-stamped reports received over a time interval as an unordered set comprising multiple data points. For instance, an unordered set may comprise multiple 3-tuple structures represented in the following format:

(X1, X2, Y),

where X1 denotes a sum of CPU usage on servers at a particular time point, X2 denotes a sum of memory usage on servers at the particular time point, and Y denotes a number of busy servers at the particular time point.

In other aspects, the system 200 may use any suitable format to represent data received in time-stamped reports. The sum of CPU usage may be expressed in percentage form, while the sum of memory usage may be converted from percentage form into bits or bytes. For example, each agent 260 may express values of memory usage on a respective server 215 in terms of percentage of memory (e.g., storage device 217) such as 70%. Assuming a server 215 includes 500 gigabytes (GB) of memory in this example, the memory usage may be converted to 350 GB.

Based on an unordered set, the central controller 205 may generate a prediction model to evaluate the relationship between Y and X1 and X2. As an example, Table 1 below depicts values of summarized data based on time-stamped reports the central controller 205 received at four different time points, which may correspond to any suitable units of time such as hours, days, weeks, months, years, etc. In addition, the sum of memory usage may be expressed in any suitable units of data such as GB, TB, PB, etc.

TABLE 1

| Time | | | |
|---|---|---|---|
| (T) | CPU Sum % (X1) | Memory Sum (X2) | # of Busy Servers (Y) |
| T1 | 0.98 | 2.11 | 7 |
| T2 | 1.39 | 2.52 | 9 |
| T3 | 1.82 | 3.21 | 11 |
| T4 | 2.08 | 3.77 | 13 |

The values in Table 1 may be represented in 3-tuple structures as follows: (0.98, 2.11, 7), (1.39, 2.52, 9), (1.82, 3.21, 11), and (2.08, 3.77, 13). While these correspond to an unordered set having data points based on four time-stamped reports, an unordered set may include data points based on many more time-stamped reports. For example, an unordered set may include data points based on a plurality of time-stamped reports received over any suitable duration such as a number days, weeks, months, years, etc.

Using data summarized in an unordered set, the central controller 205 may generate a prediction model to map the relationship between Y and X1 and X2. For example, the prediction model may be based on one or more predictive modeling schemes such as, but not limited to, machine learning, decision tree learning, generalized additive models (GAMs), data mining methods, graphical models (e.g., a probabilistic graphical model), linear regression models, logistic regression models, or any other suitable model. The modeling scheme(s) selected may vary depending for example, on the number of variables involved (e.g., different types of resource usage indicators such as network resources, I/O resources, etc.). In one aspect, the prediction model may include a linear regression algorithm expressed as follows:

Y=aX₁+bX₂+n,n˜N(0,σ²) (1)

where Y denotes predicted number of servers needed on cloud, X₁ and X₂ denote average values of X1 and X2 in an unordered set, n denotes noise, a denotes variance, σ² denotes standard deviation, and N(0, σ²) denotes noise n follows a normal distribution with a mean of zero.

Based on the data values in Table 1, parameters a and b in equation (1) may be estimated to be about 1.0614 and 2.8725, respectively. After generating a prediction model such as based on equation (1) above, the central controller 205 may train the prediction model using time series data gathered over a certain duration as training data, which may be stored in the storage device 255 (e.g., in bin 280). For example, the central controller 205 may employ one or more machine learning techniques to improve the prediction model's interpretability, shorten training times, maximize mean accuracy rate, minimize noise, etc. The central controller 205 may also employ such machine learning techniques to identify differences and similarities between the clusters 220-240 (e.g., trends in data and workloads), such that the cognitive engine service module 250 may appropriately plan and provision resources to the clusters 220-240.

That is, the cognitive engine service module 250 may analyze data associated with different clusters 220-240 to determine patterns, correlations, trends, etc. The information may be stored in the storage device 255 such as the learning data bin 280 and later used to perform predictions across different clusters 220-240. For example, some clusters 220-240 may be used for to provide web services such as for a sporting website, which may exhibit many fluctuations in traffic demand over time. Such fluctuations may be monitored, stored (e.g., in bins 270-280), and analyzed to predict demands and provision network resources accordingly. In addition, the cognitive engine service module 250 may utilize information stored in the data storage device 255 to adaptively adjust related data collection through the managers 265 and/or agents 260.

The central controller 205 may employ the prediction model to determine a number (Y) of servers 215 the cloud 210 may currently need to carry out all necessary tasks and workloads. However, it may also be desirable to determine how many servers 215 the cloud 210 may need in the future. In an embodiment, the central controller 205 may use time series data (e.g., X1 and X2) to generate a forecasting model. The forecasting model may be based on any suitable forecasting technique such as an exponential smoothing model (ESM), autoregressive integrated moving average (ARIMA) model, autoregressive moving average (ARMA) model, moving average model, weighted moving average model, Delphi method, historical analogy model, unobserved component model (UCM), Intermittent Demand Model (IDM), etc. According to some aspects, the cognitive engine service module 250 may be configured to select which forecasting technique to employ, e.g., based on information stored in the data storage device 255. Furthermore, the cognitive engine service module 250 may adjust the forecasting techniques to employ appropriate algorithms. For instance, such adjustments may be based on updated information stored in the storage device 255 (e.g., in bins 270-280), such as learning data, metadata associated with the cloud 210 and clusters 220-240, configuration information, etc.

In order to determine how many servers 215 may be necessary after a certain time in the future (ΔT), the central controller 205 may utilize time series data such as sums of past CPU usage and sums of past memory usage over certain intervals to forecast CPU usage and memory usage requirements at the future time (ΔT). As an example, Table 2 below depicts values of sums of CPU usage (X1) obtained from 60 time-stamped reports over an interval such as the last 60 months.

TABLE 2

| Time (T) | CPU Sum % (X1) |
|---|---|
| T1 | 80 |
| T2 | 67.59 |
| T3 | 74.82 |
| T4 | 60.70 |
| T5 | 62.47 |
| T6 | 51.09 |
| T7 | 54.83 |
| T8 | 56.03 |
| T9 | 69.26 |
| T10 | 55.08 |
| T11 | 66.13 |
| T12 | 60.23 |
| T13 | 65.16 |
| T14 | 69.15 |
| T15 | 80 |
| T16 | 86.54 |
| T17 | 94.92 |
| T18 | 87.36 |
| T19 | 83.01 |
| T20 | 91.09 |
| T21 | 90.91 |
| T22 | 110.32 |
| T23 | 125.83 |
| T24 | 129.36 |
| T25 | 116.15 |
| T26 | 113.95 |
| T27 | 109.36 |
| T28 | 105.41 |
| T29 | 113.74 |
| T30 | 119.73 |
| T31 | 132.23 |
| T32 | 134.17 |
| T33 | 133.09 |
| T34 | 124.02 |
| T35 | 153.10 |
| T36 | 152.30 |
| T37 | 175.92 |
| T38 | 192.77 |
| T39 | 190.84 |
| T40 | 202.87 |
| T41 | 200.87 |
| T42 | 211.91 |
| T43 | 233.28 |
| T44 | 242.98 |
| T45 | 256.07 |
| T46 | 281.80 |
| T47 | 293.73 |
| T48 | 317.92 |
| T49 | 325.73 |
| T50 | 339.18 |
| T51 | 340.75 |
| T52 | 336.55 |
| T53 | 326.81 |
| T54 | 321.40 |
| T55 | 351.34 |
| T56 | 353.52 |
| T57 | 346.68 |
| T58 | 379.31 |
| T59 | 381.69 |
| T60 | 391.14 |

According to one aspect, the central controller 205 may employ an ARIMA model, which may include non-seasonal models or seasonal models (e.g., to model time series data with seasonal fluctuations). A non-seasonal ARIMA model is typically expressed in the form of ARIMA(p,d,q), where p denotes the order of the autoregressive model, d denotes the order of differencing (e.g., number of non-seasonal differences), and q denotes the order of moving-average terms. A seasonal ARIMA model is typically expressed in the form of ARIMA(p,d,q)*(P,D,Q)ₛ, where P denotes the number of seasonal autoregressive terms, D denotes the number of seasonal differences, Q denotes the number of seasonal moving-average terms, and ₛ denotes the number of periods per season. Both non-seasonal and seasonal models may include a constant.

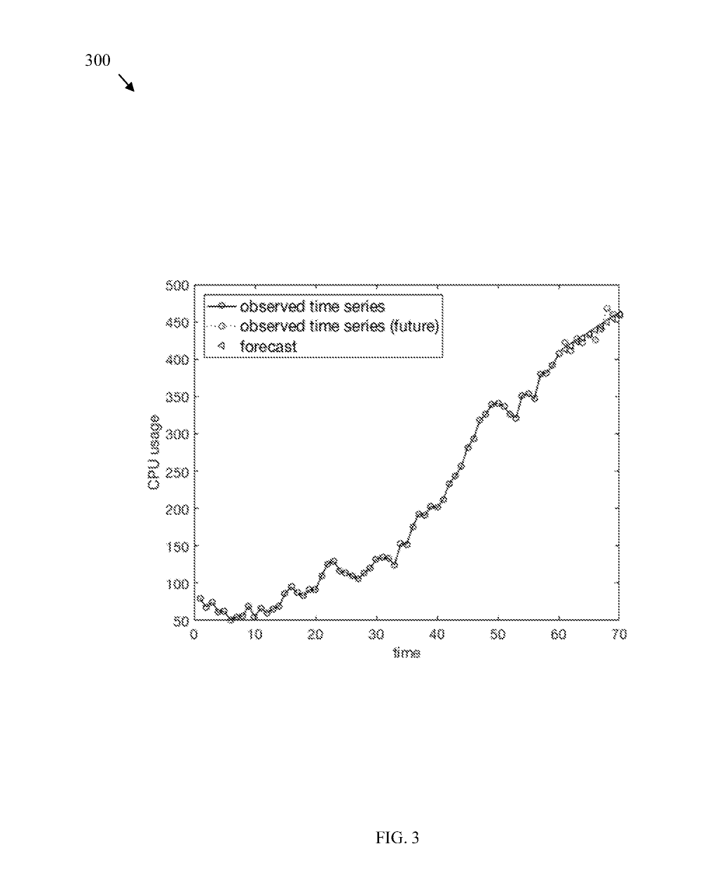

To illustrate, the central controller 205 may employ a non-seasonal ARIMA model to determine the sum of CPU usage a number of intervals after T60. For example, Table 3 below depicts an example of forecasted sums of CPU usage for the next 10 intervals after T60, and FIG. 3 is a corresponding graph 300. For comparison, Table 4 depicts an example of actual sums of CPU usage for the next 10 intervals after T60.

TABLE 3

| Time (T) | CPU Sum % (X1) |
|---|---|
| T61 | 412.71 |
| T62 | 417.92 |
| T63 | 423.13 |
| T64 | 428.33 |
| T65 | 433.54 |
| T66 | 438.75 |
| T67 | 443.96 |
| T68 | 449.16 |
| T69 | 454.37 |
| T70 | 459.58 |

TABLE 4

| Time (T) | CPU Sum % (X1) |
|---|---|
| T61 | 421.30 |
| T62 | 411.08 |
| T63 | 427.42 |
| T64 | 421.92 |
| T65 | 431.97 |
| T66 | 425.30 |
| T67 | 440.63 |
| T68 | 467.96 |
| T69 | 459.61 |
| T70 | 458.47 |

The data values in Table 3 correspond to an example in which the sums of CPU usage were determined using an ARIMA(1,1,0) model, as an example. Other ARIMA models and/or forecasting models may be used in other examples. In this example, the ARIMA(1,1,0) model returned a standard deviation (STD) of about 11.5. To forecast the sum of CPU usage at the tenth interval (T70), the central controller 205 may add the corresponding ARIMA value to a product of c*STD, where c is a constant. Thus, if c is equal to zero, the central controller 205 may simply return the ARIMA value at T70 (459.58) as the forecasted sum of CPU usage. If c is equal to three, for example, the central controller 205 may return a forecasted sum of CPU usage of about 494.08 (459.58+3*11.5).

The central controller 205 may return a forecasted sum of memory usage utilizing a similar model, except with values of sums of memory usage (X2) obtained from the same 60 time-stamped reports. For example, an ARIMA model such as discussed above would return X2 values for the next ten intervals T61-T70 and a corresponding STD. For simplicity, the STD corresponding to forecasted X2 values over future intervals (e.g., T61-T70) may be denoted as STD₂. Thus, to forecast the sum of memory usage at the tenth interval such as in the example above, the central control 205 may return the ARIMA value for X2 at T70 plus c*STD₂.

In an embodiment, the central controller 205 may utilize the forecasted sums of CPU usage and memory usage (e.g., the X1 value returned by the forecasting model for a future interval plus c*STD and the X2 value returned by the forecasting model for the future interval plus c*STD₂) as inputs to the prediction model generated earlier. As such, the output (Y) of the prediction model using equation (1) would return a forecasted number of servers 215 the cloud 210 may need to run without exceeding capacity before a certain time. Based on this output, an owner of the cloud 210 may determine to provision the cloud 210 with an appropriate quantity of resources (e.g., hardware) such that the cloud 210 may continue running for a desired duration.

In some aspects, the cognitive engine server module 250 may utilize various metadata stored in the second bin 275 to assist in the management of the provisioning resources to clusters within the cloud 210. The metadata may represent a number of rules or sets of rules that are applicable to the provisioning, deploying, monitoring, enforcement, and remediation tasks associated with a number of computing devices (e.g., servers 215) within a cloud service environment such as the cloud 210.

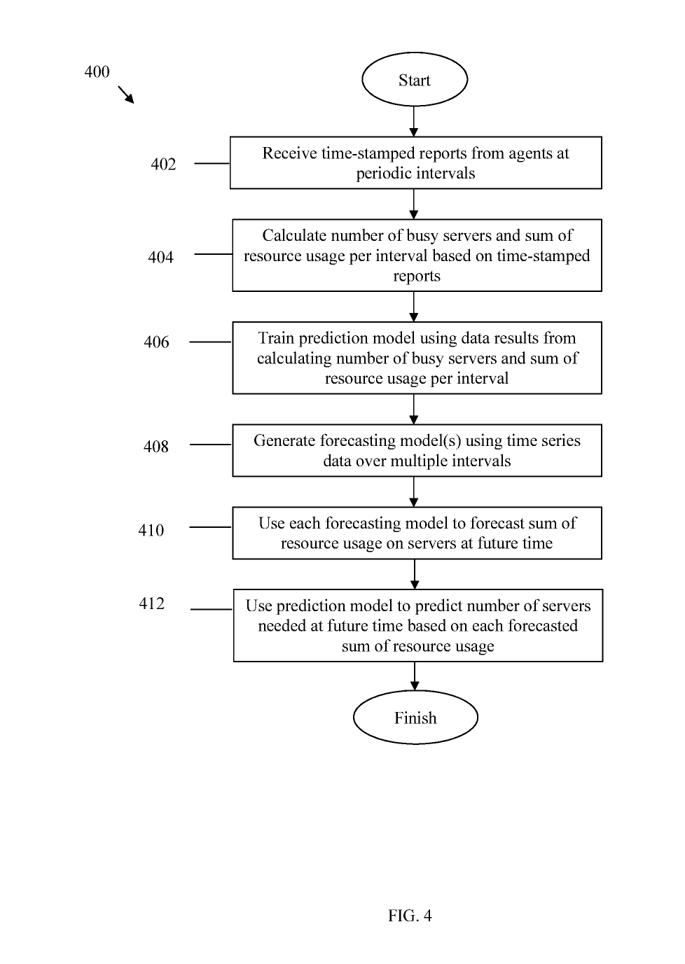

FIG. 4 is a flowchart illustrating a method 400 implemented by a network device in a cloud-based system according to an embodiment of the disclosure. The operations may be performed in the order shown, or in a different order. Further, two or more of the operations may be performed concurrently instead of sequentially. In general, the method 400 may be implemented by any suitable component in system 100 or 200 (e.g., the central controller 205), such as when planning to provision resources for a cloud-based system.

The method 400 commences at block 402, where a plurality of time-stamped reports are received from agents coupled to servers in a cloud at periodic intervals. Each time-stamped report may include a first value indicating whether a respective server is busy, and a second value indicating at least one resource usage on the respective server. As discussed above, the resource usage may refer to one or more types of resources such as a memory usage, a CPU usage, or both. At block 404, the method 400 calculates a number of servers that were busy per interval and a sum of resource usage on the servers per interval, where calculated data may be stored as an unordered set such as a multi-tuple structure. At block 406, the method 400 trains a prediction model using data calculated per interval at block 404. For example, the prediction model may be periodically trained using updated data calculations to filter out noises and improve performance.

At block 408, the method 400 generates at least one forecasting model using time series data (e.g., sums of past resource usage such as calculated at block 404) over multiple intervals, such that a separate forecasting model is generated for each type of resource usage indicated by the second value.

At block 410, the method 400 uses each forecasting model to forecast a respective sum of resource usage on the servers at a future time (e.g., forecasted sum of CPU usage and/or forecasted sum of memory usage at future time). As previously discussed, each forecasting model may return an STD associated with values forecasted over future intervals (e.g., the X1 values in Table 3). Thus, a sum of resource usage forecasted at block 410 may include a forecast value and a constant (c) multiplied by an STD returned by the forecasting model that generated the respective forecast value. At block 412, the method 400 uses the prediction model to predict a number of servers that the cloud may need to run at the future time based on each forecasted sum of resource usage from block 410.

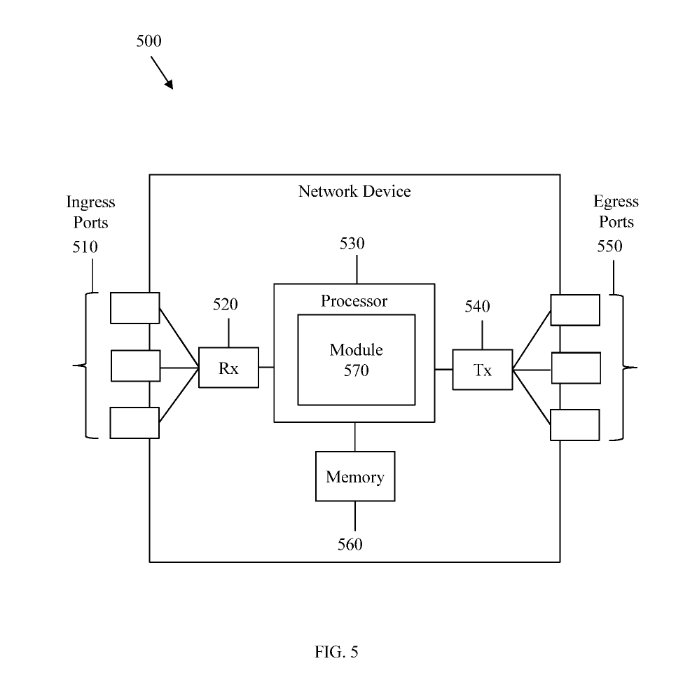

FIG. 5 is a diagram of a network device 500 according to an embodiment of the disclosure. The network device 500 is suitable for implementing the disclosed embodiments as described herein. For example, the network device 500 may include one or more components in the system 100 in FIG. 1 and/or the system 200 in FIG. 2 (e.g., central controller 205, agents 260, etc.). The network device 500 comprises one or more ingress ports 510 and a receiver unit (Rx) 520 for receiving data; at least one processor, microprocessor, logic unit, or central processing unit (CPU) 530 to process the data; a transmitter unit (Tx) 540 and one or more egress ports 550 for transmitting the data; and a memory 560 for storing the data. The network device 500 may also comprise optical-to-electrical (OE) components and electrical-to-optical (EO) components coupled to the one or more ingress ports 510, the receiver unit 520, the transmitter unit 540, and the one or more egress ports 550 for egress or ingress of optical or electrical signals.

The at least one processor 530 may be implemented by hardware and/or software. The at least one processor 530 may be implemented as one or more CPU chips, cores (e.g., as a multi-core processor), field-programmable gate arrays (FPGAs), application specific integrated circuits (ASICs), or digital signal processors (DSPs). The at least one processor 530 may be communicatively linked to the one or more ingress ports 510, receiver unit 520, transmitter unit 540, one or more egress ports 550, and/or memory 560.

The at least one processor 530 comprises a module 570 configured to implement the embodiments disclosed herein, including method 400. The inclusion of the module 570 may therefore provide a substantial improvement to the functionality of the network device 500 and effects a transformation of the network device 500 to a different state. Alternatively, the module 570 may be implemented as readable instructions stored in the memory 560 and executable by the at least one processor 530. The network device 500 may include any other means for implementing the embodiments disclosed herein, including method 400.

The memory 560 comprises one or more disks, tape drives, or solid-state drives and may be used as an over-flow data storage device, to store programs when such programs are selected for execution, or to store instructions and data that are read during program execution. The memory 560 may be volatile or non-volatile and may be read-only memory (ROM), random-access memory (RAM), ternary content-addressable memory (TCAM), or static random-access memory (SRAM).

In an embodiment, the network device 500 comprises a central controller (e.g., the central controller 205) coupled to a cloud-based system (e.g., the system 200) via a plurality of agents (e.g., the agents 260). The network device 500 comprises a non-transitory memory storage 560 comprising instructions; and one or more processors 530 in communication with the memory 560. The one or more processors 530 execute the instructions to receive (e.g., via the receiver unit 520) time-stamped reports from a plurality of agents, wherein each time-stamped report includes a server status and a server resource usage when the each time-stamped report is generated by a respective agent, calculate a number of active servers and a sum of resource usage on each server per interval based on each time-stamped report, generate a prediction model based on data results generated from calculating the number of active servers and the sum of resource usage per interval, predict a number of servers needed in the cloud-based system based on the prediction model, generate a forecasting model to forecast an amount of resource usage at a future date, and use the prediction model to predict whether a different number of servers is needed at the future date based on the forecasted amount of resource usage. According to one aspect, the forecasting model may be based on time series data associated with the one or more processors 530 calculating the sum of resource usage over multiple intervals.

In some embodiments, the resource usage included in each time-stamped report indicates an amount of memory used by the server at the time of generating the time-stamped report, an amount of computing resources used by the server at the time of generating the time-stamped report, or both. In some embodiments, the prediction model includes at least one of a machine learning model, a decision tree learning model, a graphical model, or a linear model. In some embodiments, the prediction model includes a regression model. In some embodiments, the prediction model includes a regression model and the regression model includes a logistic regression model or a linear regression model. In some embodiments, the forecasting model includes an autoregressive integrated moving average (ARIMA) model or an autoregressive moving average (ARMA) model. In some embodiments, the central controller is further configured to train the prediction model using data results generated from the one or more processors 530 calculating the number of active servers and the sum of resource usage over multiple intervals.

In an embodiment, the network device 500 comprises a non-transitory computer readable medium 560 storing computer instructions, and one or more processors 530 in communication with the non-transitory computer readable medium 560. The one or more processors 530 execute the instructions to receive (e.g., via the receiver unit 520) time-stamped reports from a plurality of agents, wherein each time-stamped report includes a server status and a server resource usage when the each time-stamped report is generated by a respective agent, calculate a number of active servers and a sum of resource usage on each server per interval based on each time-stamped report, generate a prediction model based on data results generated from calculating the number of active servers and the sum of resource usage per interval, predict a number of servers needed in the cloud-based system based on the prediction model, generate a forecasting model to forecast an amount of resource usage at a future date, and use the prediction model to predict whether a different number of servers is needed at the future date based on the forecasted amount of resource usage. According to one aspect, the forecasting model may be based on time series data associated with the one or more processors 530 calculating the sum of resource usage over multiple intervals.

In some embodiments, the resource usage included in each time-stamped report indicates an amount of memory used by the server at the time of generating the time-stamped report, an amount of computing resources used by the server at the time of generating the time-stamped report, or both. In some embodiments, the prediction model includes at least one of a machine learning model, a decision tree learning model, a graphical model, or a linear model. In some embodiments, the prediction model includes a regression model. In some embodiments, the prediction model includes a regression model and the regression model includes a logistic regression model or a linear regression model. In some embodiments, the forecasting model includes an autoregressive integrated moving average (ARIMA) model or an autoregressive moving average (ARMA) model. In some embodiments, the one or more processors 530 perform the step of training the prediction model using data results generated from calculating the number of active servers and the sum of resource usage over multiple intervals.

In an embodiment, the disclosure includes a central controller having means for implementing a method in a cloud-based data system. The central controller includes means for receiving time-stamped reports from a plurality of agents, where each time-stamped report includes a server status and a server resource usage when the each time-stamped report is generated by a respective agent. In some aspects, the central controller includes means for calculating a number of active servers and a sum of resource usage on each server per interval based on each time-stamped report, means for generating a prediction model based on data results generated from calculating the number of active servers and the sum of resource usage per interval, means for predicting a number of servers needed in the cloud-based system based on the prediction model, means for generating a forecasting model to forecast an amount of resource usage at a future date, and means for using the prediction model to predict whether a different number of servers is needed at the future date based on the forecasted amount of resource usage. In additional or alternative aspects, the forecasting model is based on time series data associated with calculating the sum of resource usage over multiple intervals.

In an embodiment, the disclosure includes a central controller coupled to a cloud-based system via a plurality of agents. The central controller includes means for storing instructions in memory, and one or more processing means in communication with the memory. The one or more processing means include means for executing the instructions to receive time-stamped reports from a plurality of agents, where each time-stamped report includes a server status and a server resource usage when the each time-stamped report is generated by a respective agent. In some aspects, the one or more processing means also execute the instructions to calculate a number of active servers and a sum of resource usage on each server per interval based on each time-stamped report, generate a prediction model based on data results generated from calculating the number of active servers and the sum of resource usage per interval, predict a number of servers needed in the cloud-based system based on the prediction model, generate a forecasting model to forecast an amount of resource usage at a future date, and use the prediction model to predict whether a different number of servers is needed at the future date based on the forecasted amount of resource usage. In additional or alternative aspects, the forecasting model is based on time series data associated with calculating the sum of resource usage over multiple intervals.

In an embodiment, the disclosure includes one or more means for executing computer instructions on a non-transitory computer-readable medium. In some aspects, the one or more means include one or more processing means for executing the computer instructions to cause the one or more processing means to perform one or more steps. In additional or alternative aspects, the one or more means include means for receiving time-stamped reports from a plurality of agents, where each time-stamped report includes a server status and a server resource usage when the each time-stamped report is generated by a respective agent. The one or more means may also include means for calculating a number of active servers and a sum of resource usage on each server per interval, means for generating a prediction model based on data results generated from calculating the number of active servers and the sum of resource usage per interval, means for predicting a number of servers needed in the cloud-based system based on the prediction model, means for generating a forecasting model to forecast an amount of resource usage at a future date, and means for using the prediction model to predict whether a different number of servers is needed at the future date based on the forecasted amount of resource usage. In additional or alternative aspects, the forecasting model is based on time series data associated with calculating the sum of resource usage over multiple intervals.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method implemented in a cloud-based data system, the method comprising:
a central controller receiving time-stamped reports from a plurality of agents, wherein each time-stamped report includes a server status and a server resource usage when the each time-stamped report is generated by a respective agent;
the central controller calculating a number of active servers and a sum of resource usage on each server per interval based on each time-stamped report;
the central controller generating a prediction model based on data results generated from calculating the number of active servers and the sum of resource usage per interval;
the central controller predicting a number of servers needed in the cloud-based system based on the prediction model;
the central controller generating a forecasting model to forecast an amount of resource usage at a future date, wherein the forecasting model is based on time series data associated with calculating the sum of resource usage over multiple intervals; and
the central controller using the prediction model to predict whether a different number of servers is needed at the future date based on the forecasted amount of resource usage.

2. The method of claim 1, wherein the resource usage included in each time-stamped report indicates an amount of memory used by the server at the time of generating the time-stamped report, an amount of computing resources used by the server at the time of generating the time-stamped report, or both.

3. The method of claim 1, wherein the prediction model includes at least one of:
a machine learning model;
a decision tree learning model;
a graphical model; or
a linear model.

4. The method of claim 1, wherein the prediction model includes a regression model.

5. The method of claim 4, wherein the regression model includes a logistic regression model or a linear regression model.

6. The method of claim 1, wherein the forecasting model includes an autoregressive integrated moving average (ARIMA) model or an autoregressive moving average (ARMA) model.

7. The method of claim 1, further comprising training the prediction model using data results generated from calculating the number of active servers and the sum of resource usage over multiple intervals.

8. A central controller coupled to a cloud-based system via a plurality of agents, comprising:
a non-transitory memory storage comprising instructions; and
one or more processors in communication with the memory, wherein the one or more processors execute the instructions to:
receive time-stamped reports from a plurality of agents, wherein each time-stamped report includes a server status and a server resource usage when the each time-stamped report is generated by a respective agent;
calculate a number of active servers and a sum of resource usage on each server per interval based on each time-stamped report;
generate a prediction model based on data results generated from calculating the number of active servers and the sum of resource usage per interval;
predict a number of servers needed in the cloud-based system based on the prediction model;
generate a forecasting model to forecast an amount of resource usage at a future date, wherein the forecasting model is based on time series data associated with calculating the sum of resource usage over multiple intervals; and
use the prediction model to predict whether a different number of servers is needed at the future date based on the forecasted amount of resource usage.

9. The network device of claim 8, wherein the resource usage included in each time-stamped report indicates an amount of memory used by the server at the time of generating the time-stamped report, an amount of computing resources used by the server at the time of generating the time-stamped report, or both.

10. The network device of claim 8, wherein the prediction model includes at least one of:
a machine learning model;
a decision tree learning model;
a graphical model; or
a linear model.

11. The network device of claim 8, wherein the prediction model includes a regression model.

12. The network device of claim 11, wherein the regression model includes a logistic regression model or a linear regression model.

13. The network device of claim 8, wherein the forecasting model includes an autoregressive integrated moving average (ARIMA) model or an autoregressive moving average (ARMA) model.

14. The network device of claim 8, wherein the central controller is further configured to train the prediction model using data results generated from calculating the number of active servers and the sum of resource usage over multiple intervals.

15. A non-transitory computer readable medium storing computer instructions, that when executed by one or more processors, cause the one or more processors to perform the steps of:
receiving time-stamped reports from a plurality of agents, wherein each time-stamped report includes a server status and a server resource usage when the each time-stamped report is generated by a respective agent;
calculating a number of active servers and a sum of resource usage on each server per interval;
generating a prediction model based on data results generated from calculating the number of active servers and the sum of resource usage per interval;
predicting a number of servers needed in the cloud-based system based on the prediction model;
generating a forecasting model to forecast an amount of resource usage at a future date, wherein the forecasting model is based on time series data associated with calculating the sum of resource usage over multiple intervals; and
using the prediction model to predict whether a different number of servers is needed at the future date based on the forecasted amount of resource usage.

16. The non-transitory computer readable medium of claim 15, wherein the resource usage included in each time-stamped report indicates an amount of memory used by the server at the time of generating the time-stamped report, an amount of computing resources used by the server at the time of generating the time-stamped report, or both.

17. The non-transitory computer readable medium of claim 15, wherein the prediction model includes at least one of:
a machine learning model;
a decision tree learning model;
a graphical model; or
a linear model.

18. The non-transitory computer readable medium of claim 15, wherein the prediction model includes a regression model.

19. The non-transitory computer readable medium of claim 18, wherein the regression model includes a logistic regression model or a linear regression model.

20. The non-transitory computer readable medium of claim 15, wherein the forecasting model includes an autoregressive integrated moving average (ARIMA) model or an autoregressive moving average (ARMA) model.

21. The non-transitory computer readable medium of claim 15, wherein the one or more processors further perform the step of training the prediction model using data results generated from calculating the number of active servers and the sum of resource usage over multiple intervals.
